(19) United States
(12) Patent Application Publication
(10) Pub. No.: US 2005/0198610 A1
(43) Pub. Date: Sep. 8, 2005

(54) Providing and using design time support

(76) Inventor: Ulf Fildebrandt, Schwetzingen (DE)

Correspondence Address: FISH & RICHARDSON, P.C., PO BOX 1022, MINNEAPOLIS, MN, 55440-1022, US

(21) Appl. No.: 10/793,108

(22) Filed: Mar. 3, 2004

(51) Int. Cl. G06F 9/44; G06F 17/00

(52) U.S. Cl. 717/100; 717/105; 717/120; 717/110; 717/109; 706/60

(57) ABSTRACT

Methods and apparatus, including computer systems and program products, for providing and using design time support for application elements. A system for designing applications includes an extension point operable to receive a definition of a user interface element to be included in an application; one or more additional extension points, each additional extension point operable to receive one or more additional support items for the user interface element independently of receiving the definition of the user interface element; a display area operable to display the user interface element in an application screen based on the definition of the user interface element and the one or more additional support items; and, a mechanism operable to invoke one or more of the additional support items. Support items may include rendering information for the user interface element, and tools operable to modify the user interface element.

### BACKGROUND

The present invention relates to data processing by digital computer, and more particularly to application development.

Computer programs or applications have both a design time aspect and a run time aspect. The design time aspect involves the development of the application, whereas the run time aspect involves user interaction with an executable instance of the application.

At design time, an application is developed in a development environment. A development environment typically includes one or more tools that assist a programmer in developing the application. Although a development environment can be an integrated development environment, such that the tools that make up the development environment are tightly coupled, a development environment can be broadly interpreted as including separate programs or tools that are not coupled together. Some development environments can include a combination of integrated and non-integrated tools.

Tools within a development environment may include, for example, a source code editor, a project manager, a user interface editor, a user interface manager, and a properties editor. A source code editor is a tool for editing source code of an application. A source code editor can be a simple word-processor, or a more complex syntax-directed editor that ensures the source code complies with the syntactical rules corresponding to a computer language in which the application is written.

A project manager may include a hierarchical view of application components that are used to develop the program.

In a graphical user interface (GUI) environment, a user interface (UI) editor may include a preview area, which may render a graphical representation of how a run time instance of an application, including UI elements, will appear. UI elements can be of different types, and can include, for example, input UI elements, view UI elements, and container UI elements. An input UI element is a control or other UI element that can receive input from a user (e.g., a button, a drop down menu, a text field, or a table UI element). A view UI element is used to display data (e.g., an image view, a text view, or a caption or label). A container UI element can be used to include other UI elements or views (e.g., a scroll container UI element can include a scroll bar). Container UI elements can specify layouts for the included UI elements or views.

UI manager may be used to display a hierarchical view of the UI elements in an application UI (e.g., a view or window). For example, a programmer may design a window with a button in the middle of the window. Because the programmer may consider the button to be a child of the window, a UI manager may display a UI tree that shows the window as a parent element and the button as a child UI element of the window.

In an integrated development environment, a properties editor may be a tool that displays different properties of UI elements and other application elements, and includes an interface to edit the properties of those application elements. For example, in a GUI environment, the properties editor may be an interactive table in which a user can modify a property by using a mouse to select the property and a keyboard to enter a value for the property.

Within a development environment, an application can be developed using various architectures, including, for example, the model-view-controller (MVC) architecture. Applications built using the MVC architecture typically include three different types of components—models, which store data such as application data; views, which display information from one or more models; and controllers, which can relate views to models, for example, by receiving events (e.g., events raised by user interaction with one or more views) and invoke corresponding changes in one or more models. The models and the controllers typically include computer program code. When changes occur in a model, the model can update its views. Data binding can be used for data transport between a view and its associated model or controller. For example, a table view can be bound to a corresponding table in a model or controller. Such a binding indicates that the table is to serve as the data source for the table view, and consequently that the table view is to display data from the table. Continuing with this example, the table view can be replaced by another view, such as a graph view. If the graph view is bound to the same table, the graph view can display the data from the table without requiring any changes to the model or controller.

In some development environments, application components can be developed by choosing various elements from a set of available elements included with the development environment. For example, a development environment can enable a developer to develop an application view by selecting UI elements from a set of predefined UI elements, configuring the selected UI elements (e.g., modifying the properties of the selected UI elements), and arranging the UI elements within the view. Additionally, in some development environments, developers are able to define and use their own custom application elements (e.g., custom UI elements).

### SUMMARY

Described herein are methods and apparatus, including computer program products, that implement techniques for providing and using design time support for application elements.

In one general aspect, the techniques feature a computer program product, which is tangibly embodied in an information carrier. The computer program product includes instructions operable to cause data processing apparatus to receive a definition for a user interface element; independently of receiving the definition for the user interface element, receive rendering information for the user interface element; independently of receiving the definition for the user interface element, receive a specification of a mechanism for modifying the user interface element; and, integrate the user interface element into an application as soon as the definition of the user interface element is received.

Implementations may include one or more of the following features. The definition for the user interface element may include a specification of one or more properties of the user interface element and a specification of a data type for each of the one or more properties of the user interface element. The definition for the user interface element may further include a specification of an event that can be triggered by the user interface element, and integrating the user interface element may include displaying the property of the user interface element and enabling a user to modify the property of the user interface element. The rendering information may include one or more graphic files. The rendering information may include rendering code. The rendering code may be executable. Integrating the user interface element may include, if the rendering information has not been received, rendering the user interface element in a preview area using default rendering information, and if the rendering information has been received, rendering the user interface element in the preview area using the rendering information. The default rendering information may include a text label with a name for the user interface element. The mechanism for modifying the user interface element may include an editor or a wizard. The mechanism for modifying the user interface element may be operable to generate objects associated with the user interface element. The mechanism for modifying the user interface element may be operable to generate a binding between the user interface element and an application element. Integrating the user interface element may include, if the mechanism for modifying the user interface element has been received, enabling a user to invoke the mechanism for modifying the user interface element. Enabling the user to invoke the mechanism may include registering the mechanism in a development framework. Enabling the user to invoke the mechanism may include modifying a context item associated with the user interface element. The context item may include a context menu and modifying the context item may include adding a name associated with the mechanism to the context menu. Implementations may also be included in an apparatus.

In an other aspect, a method of developing applications includes specifying for a user interface element one or more properties and a data type for each of the one or more properties; independently of specifying the one or more properties and the data type for each of the one or more properties, specifying rendering information to be used in place of default rendering information; and, integrating the user interface element into an application, wherein integrating the user interface element includes rendering the user interface element in a preview area using the default rendering information, if no rendering information has been specified; and, rendering the user interface element in a preview area using the specified rendering information, if rendering information has been specified.

Implementations may include one or more of the following features. The method may further include specifying a mechanism for modifying the user interface element and invoking the mechanism to modify the user interface element. The method of specifying for a user interface element one or more properties and a data type for each of the one or more properties may further include specifying at least one event.

In an other aspect, a system for designing applications includes a first extension point operable to receive a definition of a first user interface element to be included in an application; one or more additional extension points, each additional extension point operable to receive one or more additional support items for the first user interface element independently of receiving the definition of the first user interface element; a display area operable to display the first user interface element in an application screen based on the definition of the first user interface element and the one or more additional support items; and, a mechanism operable to invoke one or more of the additional support items.

Implementations may include one or more of the follow features. The additional support items may include rendering information for the first user interface element. The additional support items may include a tool operable to modify the first user interface element. The mechanism may include a context menu for the first user interface element. The first extension point may be further operable to receive a definition of a second user interface element to be included in the application, the second user interface element being of a different type than the first user interface element. Additional support items may be independent of the definition of the first user interface element. Additional support items may be independent of each other.

Design time support can be implemented to realize one or more of the following advantages. A development environment can include multiple points to plug-in various levels of support for UI elements. Accordingly, developers can develop custom UI elements in multiple steps. In one implementation, the first step is to provide a basic definition for a UI element. After the basic definition has been specified, the UI element can be integrated into an application using the tools in a development environment. Subsequently, the application developer (or a different person, e.g., a control developer) can specify additional support items for the UI element using the other plug-in points in the development environment. Such support items (e.g., wizards) can be used by the development environment to further integrate the UI element into applications. Advantageously, a developer does not have to provide all the different types of support items for a UI element before the UI element can be integrated into applications. Where a support item is not provided for a UI element, the development environment can provide default support (e.g., a default wizard), or simply disable actions or tools related to that support item (e.g., disabling a menu option for invoking a wizard).

The design time integration of a UI element into an application may be generic, and the same process can be used to integrate different types of UI elements into applications. The design of UI elements and the design of applications can be independent of each other; thus, controls can be designed by control developers on a time frame that is not related to the development and release of applications, and new or updated controls can easily be integrated into applications as soon as they are available.

The details of one or more implementations of the invention are set forth in the accompanying drawings and the description below. Further features, aspects, and advantages will become apparent from the description, the drawings, and the claims.

### BRIEF DESCRIPTION OF THE DRAWINGS

These and other aspects will now be described in detail with reference to the following drawings.

FIG. 1 is an illustration of a development environment.

FIG. 2 is a flowchart of a sample process for providing and using design time support for UI elements.

FIG. 3 is a flowchart of a sample process for using design time support to integrate a user interface element into an application.

FIGS. 4A and 4B are parts of a diagram illustrating a model for user interface elements.

Like reference numbers and designations in the various drawings indicate like elements.

### DETAILED DESCRIPTION

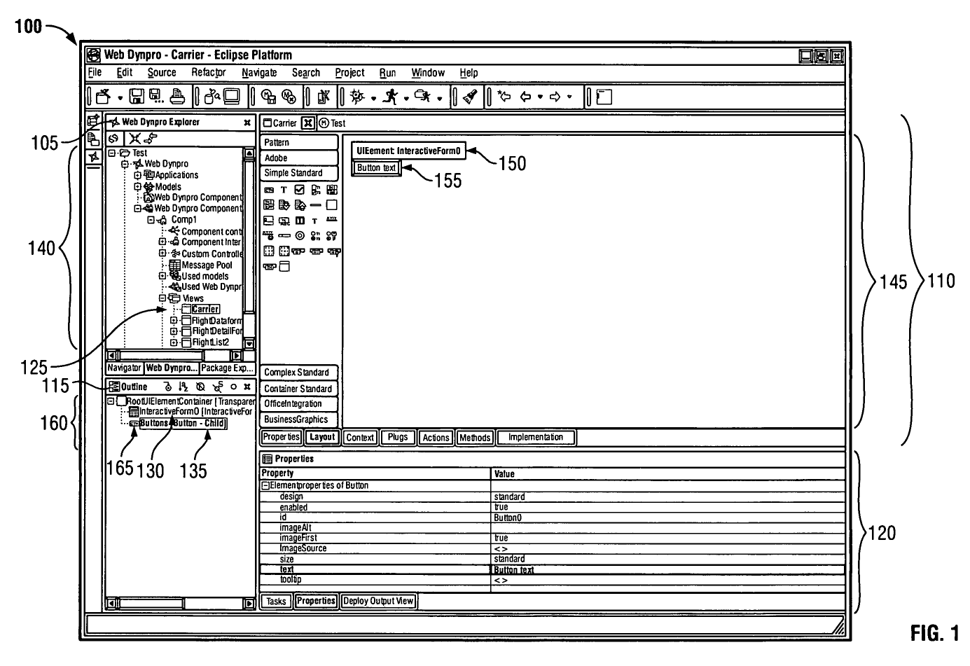

FIG. 1 illustrates an example integrated development environment 100. The integrated development environment 100 includes tools such as a project manager 105, a user interface (UI) editor 110, a UI manager 115, and a properties editor 120. The tools in the integrated development environment 100 depict development of an application that includes a view 125 and two UI elements (an interactive form UI element 130, and a button UI element 135).

The project manager 105 includes a hierarchical view 140 of various application components. Application components are used to develop applications. The integrated development environment depicted in FIG. 1 can be used to develop applications using the model-view-controller architecture (MVC). Thus, the hierarchical view 140 of application components includes a hierarchy of models, views, and controllers. The selected view 125 is one of the views in the hierarchical view 140 of application components. In alternative implementations, differing levels of detail may be provided in the hierarchy view 140 of application components. Also, in alternative implementations other types of programming architectures may be depicted in the project manager 105.

The UI editor 110 is used for arranging UI elements, and includes a preview area 145. The preview area 145 depicts how a run time instance of an application may appear. For example, in FIG. 1, the preview area 145 depicts how the view 125 (which is selected in the hierarchical view 140 of the application components) appears. As shown in the UI tree 160 at the bottom left corner of FIG. 1, the view 125 includes two UI elements (the interactive form UI element 130 and the button UI element 135). Those two UI elements are represented by graphical representations 150, 155 in the preview area 145. As shown in FIG. 1, the two UI elements are currently arranged in the upper left corner of view 125, but UI editor 110 can be used to specify a different layout of the UI elements.

If the integrated development environment 100 receives information on how to render a UI element, that information can be used to render the UI element. For example, the preview area 145 displays an interactive form UI element 130 and a button UI element 135 as graphical representations 150 and 155. Information received by the integrated development environment 100 is used to render the button UI element 135 in the preview area 145. Because the button UI element 135 represents a button, information received by the integrated development environment 100 defines how to render the button UI element 135 such that it graphically represents a button. The rendering information for a UI element can be information provided as part of the original integrated development environment 100 (e.g. rendering information for a button that is part of an original library of UI elements), or it can be information provided in a definition of a UI element that is separately developed (i.e. custom rendering information for a custom UI element). The rendering information for the graphical representation 155 can be an image provided as an image file. If rendering information for a specific UI element is not provided, the integrated development environment 100 can render the UI element using a default graphical representation. Any graphical representation can be used. For example, rendering information was not received for the interactive form UI element 130, thus a default graphical representation 150 is rendered. The default graphical representation 150 is a textbox, including a text label indicating that the graphical representation 150 is named “InteractiveForm0” which corresponds to the name of the interactive form UI element 130.

In alternative implementations, the integrated development environment 100 need not render a UI element according to rendering information provided to the integrated development environment 100. For example, the integrated development environment can always render a UI element using a default graphical representation.

In alternative implementations the rendering information for a UI element may include more than a static graphical representation. For example, the rendering information may include rendering code. The rendering code can be written in a language that is suitable for execution in the integrated development environment 100. For example, Hyper Text Markup Language (HTML) and JavaScript code can be executed in the integrated development environment 100. For example, a UI element can be defined to be a tabstrip UI element that includes multiple tab UI elements. The rendering code can specify an order of displaying the tab UI elements in the tabstrip UI element.

The UI manager 115 displays UI elements of an application using a UI tree, which is a hierarchical view of UI elements. For example, the UI elements for view 125 are displayed in the UI manager 115 as part of the UI tree 160. The UI manager can render graphical representations, known as outline view icons, of UI elements if information is received detailing how the outline view icons should be rendered. For example, the outline view icon 165 is a graphical representation of the button UI element 135, which is a button. If information is not provided for rendering an outline view icon of a UI element, the integrated development environment 100 can render the outline view icon using a default graphical representation. The default graphical representation may be a default icon. For example, the outline view icons for the interactive form UI element 130 is rendered using a default icon. In alternative implementations the UI manager 115 need not provide the ability to render UI elements based on information received by the integrated development environment 100.

The properties editor 120 is a mechanism for modifying the properties of an application element, such as a UI element. A property of a UI element can be any type of property, such as a property that affects the appearance of a UI element, a property that affects how a UI element relates to or interacts with one or more other application elements, or a property that stores data related to the UI element. For example, if properties of the button UI element 135 are displayed in a properties editor, the properties may include the height and width. In alternative implementations, other types of mechanisms can be provided for modifying the properties of an UI element. For example, a wizard may be provided.

In addition to modifying the properties of a UI element, the UI element may be modified in other ways. For example, one or more sub-objects may be defined and associated with the UI element. Or the UI element may be bound to or otherwise associated with other UI elements or components in the application. Various tools or mechanisms (e.g., wizards) can be provided to enable such modifications.

In alternative implementations a mechanism for modifying the UI element can be operable to generate one or more objects and/or sub-objects associated with the UI element. For example, for a table UI element, a wizard can be provided to generate sub-objects such as column and row UI elements for a design time instance of the table UI element. In alternative implementations, the mechanism for modifying the UI element may be operative to generate a binding between a UI element and an application element. For example, the button UI element 135 may be involved in the design of an application that is based on the MVC architecture. A binding may be generated between the UI element 135 and other applications elements, such as a model or a controller.

The integrated development environment 100 of FIG. 1 depicts various design time support items that have been provided to integrate UI elements into an application. The design time support items include support for rendering in a preview area (e.g. the preview area 145), support for rendering outline view icons (e.g. the outline view icons in the UI manager 115), and support for a mechanism for editing the UI element (e.g. the properties editor 120). In alternative implementations, additional or different support items and combinations of support items may be provided. For example, context item information may be received. A context item can be an item for a context menu of a UI element. In a mouse-driven UI environment, a context menu can appear when the UI element is right-clicked. The context menu can include a context menu item such as “start wizard.”

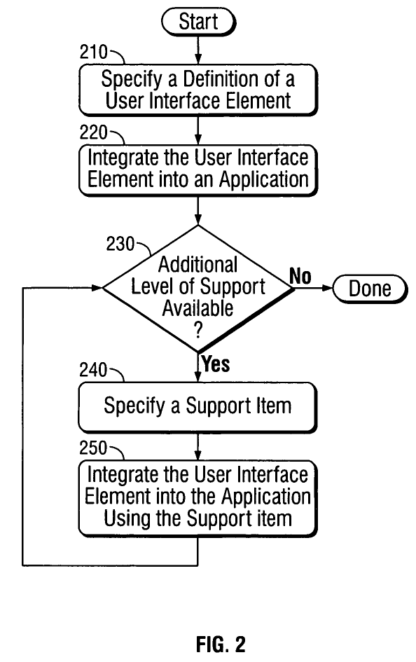

FIG. 2 is a flowchart of a sample process for providing and using design time support for UI elements. A definition of a UI element is specified at 210. Specifying the definition of the UI element can include specifying one or more properties of the UI element and a data type for each property. A property can define any aspect of the UI element, including the appearance of a UI element, how a UI element relates to or interacts with application components, or data related to the UI element. A property that is specified is not necessarily modifiable in a properties editor, such as the properties editor 120; nor is a property that is modifiable in properties editor necessarily a property that is specified. For example, it may be inherent that all UI elements have a property for the size of a UI element; thus, the size of the UI element need not be specified to define the UI element, yet the size may be modifiable in a properties editor for the UI element. The properties of a UI element may be specified in a programming language such as XML, or any other programming language. A data type can be specified for each property so that a property can be understood within the namespace of an application that is being developed.

At 220, the UI element is integrated into an application. The application may be a development environment, such as the integrated development environment 100. Integrating the UI element into the application allows the UI element to be used to develop an application. Integrating the UI element may include enabling a user to choose the UI element as a UI element that can be included in an application which is being developed, rendering the UI element in a preview area, and/or enabling a user to invoke a mechanism for modifying the UI element.

If, at 230, an additional support item is available, the support item can be specified at 240. An additional support item is any type of design time support related to the UI element which may assist in the development of an application (i.e., in the integration of the UI element into the application). Additional support items can include enhanced information or services for the UI element. Examples of enhanced information include: rendering information to render a UI element in an outline view of a UI tree, such as the outline view icons used in the UI tree 160; rendering information to render the UI element in a preview window, such as the preview area 145; and, context item information to support a modified context menu, such as a context menu that includes an additional context menu item “invoke wizard.” A support item that is a service may be a mechanism for providing special functionality, such as a wizard.

Support items do not necessarily change the basic function of a UI element. Thus, support items may be independent of the definition of a UI element. For example, a support item can include additional information or services for a UI element without necessarily referring to or modifying the basic definition or previously provided support items for the UI element. If support items are independent of each other, a first support item, such as a wizard may be provided regardless of a second support item, such as rendering information. Also, a support item that is provided for one type of UI element need not be provided for other types of UI elements. For example, a button UI element may have a support item that is a wizard while an interactive form UI element need not have the wizard support item and may, instead, have a support item including additional rendering information. In this manner, the process illustrated in FIG. 2 serves as a generalized mechanism for adding design time support for UI elements.

The definition for a UI element and additional support items may be specified through mechanisms such as plug-ins and/or extension points. In a development environment, extension points are interfaces in a development environment (e.g., in a tool in the development environment) to which plug-ins or other extension modules can be attached in order to enhance the functionality of the development environment. The protocol for using an extension point can differ depending on the development environment in which extension points are offered.

Once the definition for a UI element and additional support items, if they exist, are specified in one or more plug-ins, the UI element can be integrated into the development environment (e.g. a computer program such as an integrated development environment) at 250 using the support item. For example, if an additional support item is enhanced information for a UI element, such as an outline view icon, the enhanced information can be integrated by rendering the outline view icon in an outline view of a UI tree. In another example, if an additional support item is a service, such as a wizard, the service can be integrated by enabling the service. For a wizard, enabling may include associating the wizard with a UI element such that a user can invoke the wizard by, for example, selecting a menu item in a context menu corresponding to the wizard.

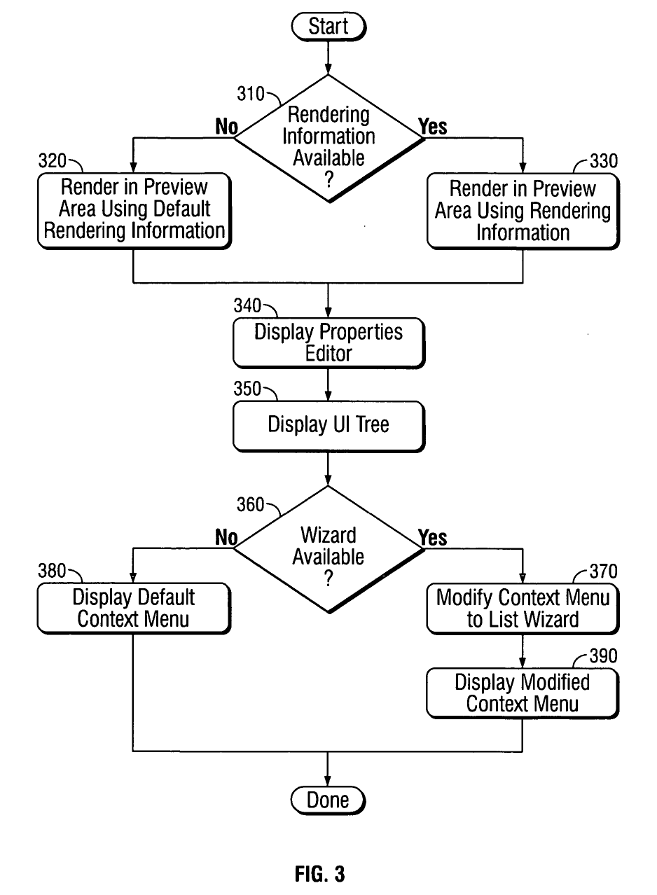

FIG. 3 is a flowchart of a sample process for using design time support to integrate a UI element into an application. At 310, a decision is made as to whether rendering information is available. If rendering information is available, a UI element is rendered in a preview area using the rendering information that is available, at 320. If rendering information is not available, the UI element is rendered in the preview area using default rendering information, at 330. Rendering information defines how the UI element is graphically represented. Rendering information can include, for example, an image file or rendering code. Rendering code may be, for example, HTML code or JavaScript code. The code may provide more than a static graphical representation of the UI element in a development environment. Also, the rendering code may use properties of the UI element to render the UI element. If the properties of the UI element are modified, rendering code may cause rendered version of the UI element to reflect the modified properties. For example, the button UI element 135 includes a property “text” (which is selected in the properties editor 120) for the text on the face of the button UI element. Rendering code can define how to display the value for the text property in the preview area 145. If the value for the text property were to change from “Button text” to “Submit,” the corresponding rendition of the button (graphical representation 155) may change to reflect the change of the text property.

At 340, a properties editor is displayed. The properties editor allows properties of the UI element to be modified. The properties editor may be a properties editor such as the properties editor 120. In alternative embodiments different types of mechanisms for modifying the UI element may be provided.

A UI tree is displayed at 350. The UI tree depicts a hierarchy of UI elements that may exist in, for example, a view of an application designed using the MVC architecture. Displaying the UI tree may include rendering graphical representations of the UI elements as part of the UI tree.

If a wizard is available at 360, a context menu for the UI element is modified at 370. If a wizard is not available, a default context menu is available for the UI element. In a mouse-driven graphical user interface (GUI) environment, a context menu is a menu that changes depending on the position of the mouse cursor (i.e., depending on the position of the mouse cursor, the context in which the mouse cursor exists may differ, and the menu displayed in conjunction with the mouse cursor may change accordingly). For example, a context menu may appear in a preview area, such as the preview area 145, if a user right-clicks while the mouse cursor is over a rendered UI element, such as the graphical representation 155. The context menu may differ as compared to when the mouse cursor is over an area of the preview area 145 that does not include a rendered UI element. The context menu itself is one type of context item and in alternative implementations support for other types of context items may be provided.

Modifying the context menu can include adding an additional context menu item, e.g., an item for invoking a support item such as a wizard. Continuing with the prior example, if a wizard is available for the UI element 130, the corresponding context menu can be modified to include an item such as “start button wizard” when the context menu for the UI element 130 is displayed. Modifying the context menu to list the wizard (and enabling a user to invoke the mechanism for modifying the UI element) is part of integrating the UI element into an application. In alternative implementations, enabling a user to invoke a mechanism for modifying the UI element also may include registering the mechanism in a development framework. In alternative implementations, modifying the context menu may include enabling context menu items that are typically disabled.

Once a context menu is modified, the modified context menu is displayed at 390. If the context menu is not modified, a default context menu is displayed at 380. The default context menu is the standard context menu that would appear for a UI element, and need not include additional context menu items such as “start wizard.” Alternatively, a context menu item, such as “start wizard” may be disabled in a default context menu, thus displaying a default context menu may include displaying disabled context menu items differently from enabled context menu items. For example, if a default context menu item for a UI element is “start wizard” and a corresponding wizard does not exist such that the wizard context menu item is disabled, the default context menu item may be displayed as a text color that is darker than context menu items that are enabled.

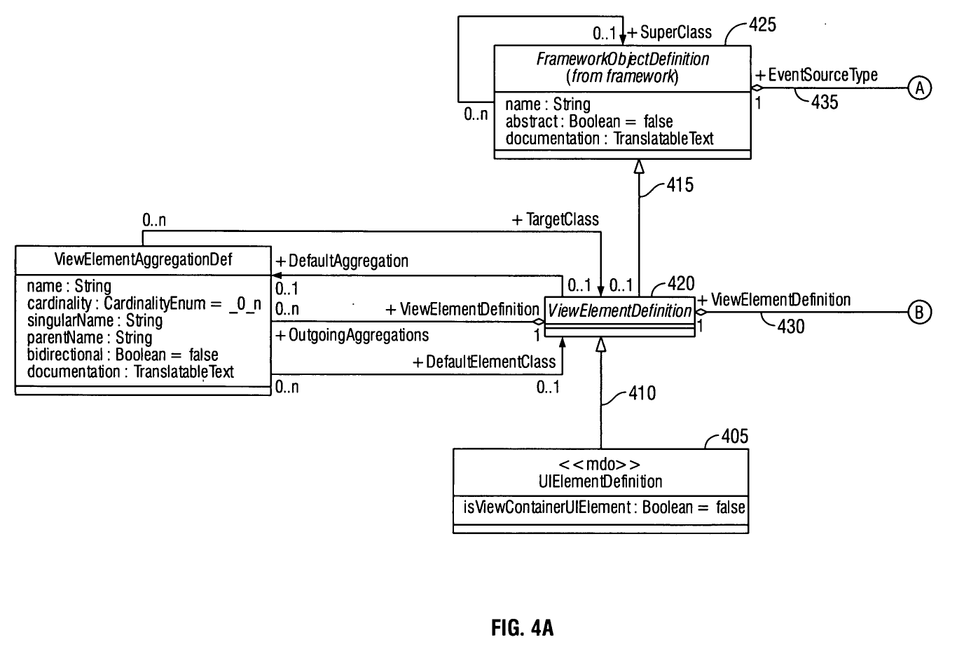

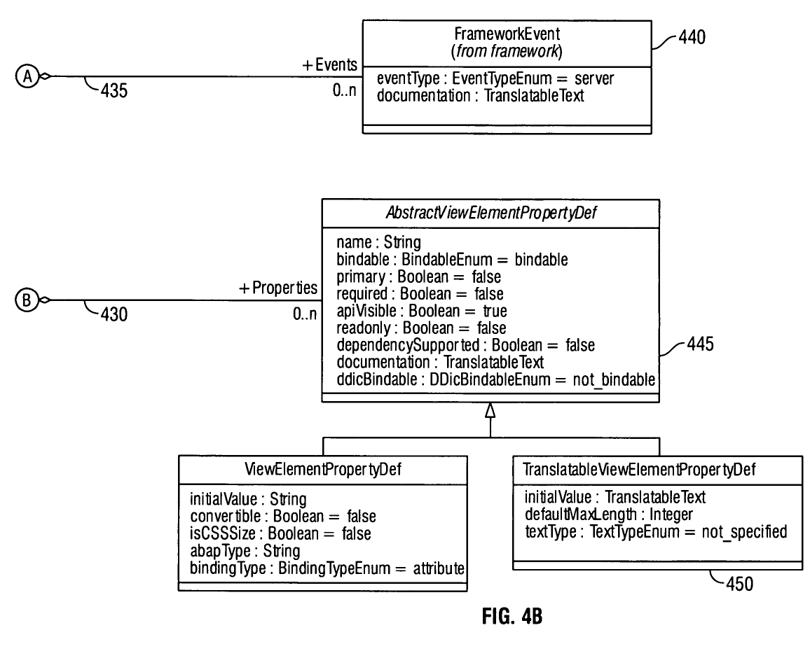

A model can be used to describe the structure of a UI element and support items for the UI element. FIGS. 4A and 4B are parts of a diagram, similar to a Unified Modeling Language (UML) diagram, that illustrate a portion of an example model, and can be used to define a UI element. The class UIElementDefinition 405 represents a definition for a UI element. The lines 410 and 415 with unfilled arrows denote that the class UIElementDefinition 405 is derived from the abstract classes ViewElementDefinition 420 and FrameworkObjectDefinition 425. As the aggregation relationships 430 and 435 show, the class FrameworkObjectDefinition 425 includes an aggregation of any number of FrameworkEvents 440, and the class ViewElementDefinition 420 includes an aggregation of any number of AbstractViewElementPropertyDefs 445. In other words, a basic UI element definition can include a list of events and a list of properties for the UI element. As described above, properties can be used to define the appearance of a UI element, define how a UI element relates to or interacts with one or more other application elements, or store data related to the UI element. As shown by the “0 . . . n” cardinality indicated at the right side of the aggregation relationship 430, a UI element can include any number of properties. Moreover, as shown in the class AbstractViewElementPropertyDef 445, each property can have multiple aspects, each of which is an attribute. For example, the “name” attribute can be used to specify a name of a property, the “required” attribute can be used to specify whether a developer must specify a value for this property, and the readonly attribute can specify whether a the values in a derived instance of the abstract class AbstractViewElementPropertyDef 445 can be modified.

FIGS. 4A and 4B will now be described in combination with parts of an example UI element written in Extensible Markup Language (XML) pseudo-code. The example UI element may be an abstract class named “AbstractButton” from which the button UI element 135 is derived.

The following pseudo-code declares the definition of the UI element:

<UIElementDefinition
xmlns=“http://xml.sap.com/2002/10/metamodel/webdynpro”
xmlns:IDX=“urn:sap.com:WebDynpro.UIElementDefinition:2.0”
mmRelease=“6.30” mmVersion=“2.0” mmTimestamp=“1070982712575”
abstract=“true” name=“AbstractButton”
package=“com.sap.ide.webdynpro.uielementdefinitions”
masterLanguage=“en”>

The XML element UIElementDefinition corresponds to the class UIElementDefinition 405. As discussed above, each UIElementDefinition can include any number of events, known as FrameworkEvents 440. An event can occur when a user interacts with the UI element. In the following pseudo-code an event is defined for the UI element AbstractButton. The event is named “onAction,” and may correspond to a mouse-click in a mouse-driven GUI environment. The FrameworkObjectDefinition element corresponds to the abstract class FrameworkObjectDefinition 425, which can include any number of FrameworkEvents, as depicted by the aggregation relationship 435 with the annotation “0 . . . n.”

<FrameworkObjectDefinition.Events>

<FrameworkEvent name=“onAction” />

</FrameworkObjectDefinition.Events>
<FrameworkObjectDefinition.SuperClass>

<Core.Reference
package=“com.sap.ide.webdynpro.uielementdefinitions”

name=“AbstractCaption” type=“UIElementDefinition” />
</FrameworkObjectDefinition.SuperClass>

As described above, in addition to multiple events, each UIElementDefinition can also include multiple properties. Each property can define an aspect of the UI element. In the following pseudo-code a property named “text” is defined for the AbstractButton. The “text” property is of the data type TranslatableViewElementPropertyDef, which corresponds to the class TranslatableViewElementPropertyDef 450. In this example, the “text” property corresponds to text that is displayed on the face of a button in a GUI.

<ViewElementDefinition.Properties>

<TranslatableViewElementPropertyDef ddicBindable=“bindable”

defaultMaxLength=“255” dependencySupported=“true”
name=“text” textType=“button”>

The above code lists aspects of a “text” property of a button, for example, the defaultMaxLength attribute specifies that the maximum default length for a value of this property is 255 characters. In addition, various other aspects can be specified for each property, as shown in FIGS. 4A and 4B. For example the ddicBindable attribute indicates that the property supports data binding.

The schema illustrated in the diagram of FIGS. 4A and 4B is one possible way to define a UI element. In alternative implementations, a schema including different classes, abstract classes, roles, and/or data values may define a UI element. Also, in alternative implementations, different programming paradigms, other than the object-oriented paradigm may be used to define a UI element.

The design time support for computer programs described here can be implemented in digital electronic circuitry, or in computer hardware, firmware, software, or in combinations of them. The design time support can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of design time support can be performed by one or more programmable processors executing a computer program to perform functions by operating on input data and generating output. Method steps can also be performed by, and apparatus of design time support can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, a development environment including design time support can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Design time support can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Design time support need not be limited to UI elements, and in alternative implementations, design time support may be provided for other application elements and/or application components. Also, although the processes for providing design time support and integrating user interface elements into applications discussed herein are shown as being composed of a certain number of different operations, additional and/or different operations can be used instead. Similarly, the operations need not be performed in the order depicted. The invention has been described in terms of particular embodiments. Other embodiments are within the scope of the following claims.

1. A computer program product, tangibly embodied in an information carrier, the computer program product comprising instructions operable to cause data processing apparatus to:
receive a definition for a user interface element;
independently of receiving the definition for the user interface element, receive rendering information for the user interface element;
independently of receiving the definition for the user interface element, receive a specification of a mechanism for modifying the user interface element; and
integrate the user interface element into an application as soon as the definition of the user interface element is received.

2. The product of claim 1, wherein the definition for the user interface element comprises:
a specification of one or more properties of the user interface element; and
a specification of a data type for each of the one or more properties of the user interface element.

3. The product of claim 2, wherein integrating the user interface element comprises:
displaying the one or more properties of the user interface element; and
enabling a user to modify the one or more properties of the user interface element.

4. The product of claim 1, wherein the rendering information comprises one or more graphic files.

5. The product of claim 1, wherein the rendering information comprises rendering code.

6. The product of claim 1, wherein integrating the user interface element comprises:
if the rendering information has not been received, rendering the user interface element in a preview area using default rendering information; and
if the rendering information has been received, rendering the user interface element in the preview area using the rendering information.

7. The product of claim 1, wherein the mechanism for modifying the user interface element comprises a wizard.

8. The product of claim 1, wherein the mechanism for modifying the user interface element is operable to generate one or more objects associated with the user interface element.

9. The product of claim 1, wherein the mechanism for modifying the user interface element is operable to generate a binding between the user interface element and an application element.

10. The product of claim 1, wherein integrating the user interface element comprises:
if the mechanism for modifying the user interface element has been received, enabling a user to invoke the mechanism for modifying the user interface element.

11. The product of claim 10, wherein enabling the user to invoke the mechanism comprises registering the mechanism in a development framework.

12. The product of claim 10, wherein enabling the user to invoke the mechanism comprises modifying a context item associated with the user interface element.

13. A method of developing applications, the method comprising:
specifying for a user interface element one or more properties and a data type for each of the one or more properties;
independently of specifying the one or more properties and the data type for each of the one or more properties, specifying rendering information to be used in place of default rendering information; and
integrating the user interface element into an application, wherein integrating the user interface element includes:
rendering the user interface element in a preview area using the default rendering information, if no rendering information has been specified; and
rendering the user interface element in a preview area using the specified rendering information, if rendering information has been specified.

14. The method of claim 13, wherein the method further comprises:
specifying a mechanism for modifying the user interface element; and
invoking the mechanism to modify the user interface element.

15. A system for designing applications comprising:
a first extension point operable to receive a definition of a first user interface element to be included in an application;
one or more additional extension points, each additional extension point operable to receive one or more additional support items for the first user interface element independently of receiving the definition of the first user interface element;
a display area operable to display the first user interface element in an application screen based on the definition of the first user interface element and the one or more additional support items; and
a mechanism operable to invoke one or more of the additional support items.

16. The system of claim 15, wherein the additional support items comprise rendering information for the first user interface element.

17. The system of claim 15, wherein the additional support items comprise a tool operable to modify the first user interface element.

18. The system of claim 15, wherein the first extension point is further operable to receive a definition of a second user interface element to be included in the application, the second user interface element being of a different type than the first user interface element.

19. The system of claim 15, wherein the additional support items are independent of the definition of the first user interface element.

20. The system of claim 15, wherein the additional support items are independent of each other.
